(19) United States
(12) Patent Application Publication
(10) Pub. No.: US 2004/0210493 A1
(43) Pub. Date: Oct. 21, 2004

(54) Return material authorization look-up and auto-receipt

(76) Inventors: Marc Alan Sherman, Fort Worth, TX (US); Jeffrey Ronell Smith, Edmund, OK (US)

Correspondence Address: David W. Carstens, PO Box 802334, Dallas, TX, 75380-2334, US

(21) Appl. No.: 10/420,049

(22) Filed: Apr. 21, 2003

(51) Int. Cl. G06F 17/60

(52) U.S. Cl. 705/28

(57) ABSTRACT

The present invention provides a method, program and system for processing product returns. In response to a single input of a returned item's identification (i.e. scanning a serial number), the invention matches the returned item with a return authorization. This authorization is created if the returned item meets specified criteria. The invention then automatically updates inventory files to include the returned item, designating the item as a return that is not available for resale. The invention also creates a return-to-manufacturer order and an account receivable for warranty exchange. In one embodiment of the present invention, a manufacturer file is also automatically updated to allow the manufacturer to identify the returned item as well as the source of the return.

### BACKGROUND OF THE INVENTION

1. Technical Field

The present invention relates generally to product returns, and more specifically to an automated system for tracking returned products and updating inventory files to reflect the return.

2. Description of Related Art

Product returns often require a customer to obtain a Return Material Authorization (RMA) number before making a return. The customer first contacts the company in question and informs the company of the return. The company then issues a RMA number to the customer.

The RMA number helps to alert company personnel of return and helps to trace the history of the product in question by matching it with the customer when it arrives back in the company's possession.

Product return includes several steps in connection with the returned item. When a returned item arrives back in the company's possession, the product is often identified by a serial number, e.g., the electronic serial numbers (ESNs) used for mobile phones. This identification is then matched to a RMA number. This allows the company to trace the history of the item and know where it was originally sent. This also allows the company to determine if the return meets specified criteria, e.g., warranty periods and covered defects. Matching the RMA and item identifier can be used to bring the item back into inventory and create a return order or credit for a vendor or customer.

Currently, all of these steps are separate processes and must be performed manually. Therefore, it would be desirable to have a method of automatically matching returned items to authorized returns and acknowledging the receipt of the items in inventory in one integrated process.

### SUMMARY OF THE INVENTION

The present invention provides a method, program and system for processing product returns. In response to a single input of a returned item's identification (i.e. scanning a serial number), the invention matches the returned item with a return authorization. This authorization is created if the returned item meets specified criteria. The invention then automatically updates inventory files to include the returned item, designating the item as a return that is not available for resale. The invention also creates a return-to-manufacturer order and an account receivable for warranty exchange. In one embodiment of the present invention, a manufacturer file is also automatically updated to allow the manufacturer to identify the returned item as well as the source of the return.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4 depicts a flowchart illustrating the process of building indices for return receipts in accordance with the present invention;

FIG. 5 depicts a flowchart illustrating the process of maintaining a manufacturer file in accordance with the present invention; and

FIG. 6 depicts a flowchart illustrating an automated process of receiving return material authorization (RMA) orders in accordance with the present invention.

### DETAILED DESCRIPTION OF THE INVENTION

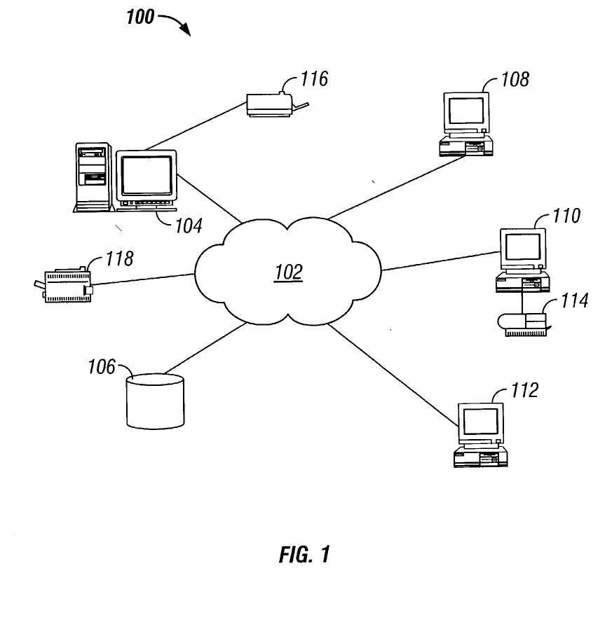

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 includes printers 114, 116, and 118, and may also include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

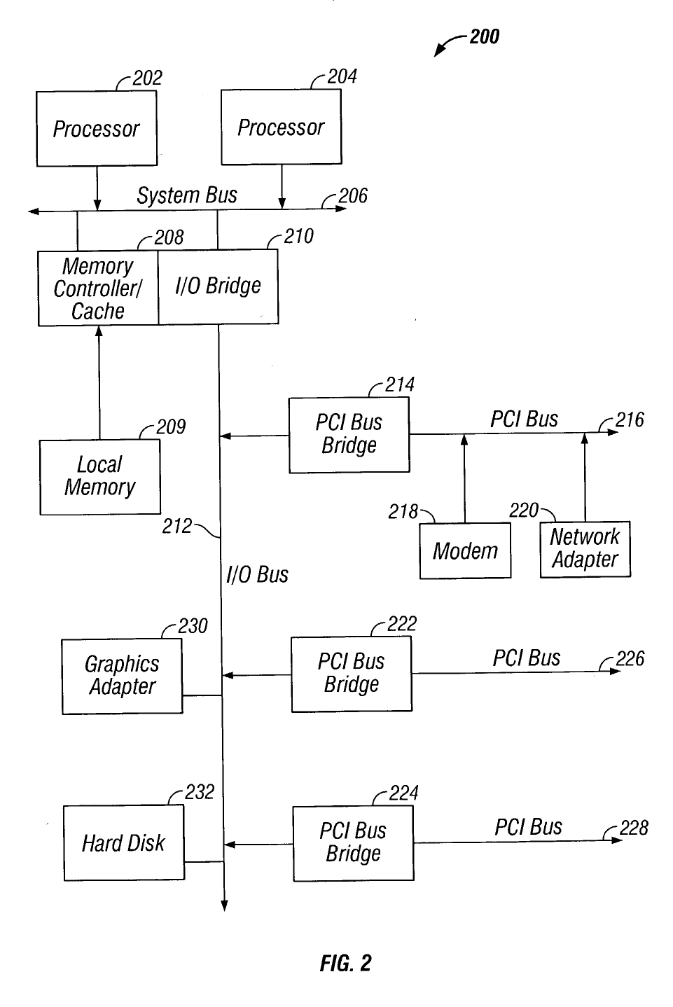

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an eServer pSeries system, a product of International Business Machines Corporation in Armonk, New York, running the Advanced Interactive Executive (AIX) or Linux operating systems.

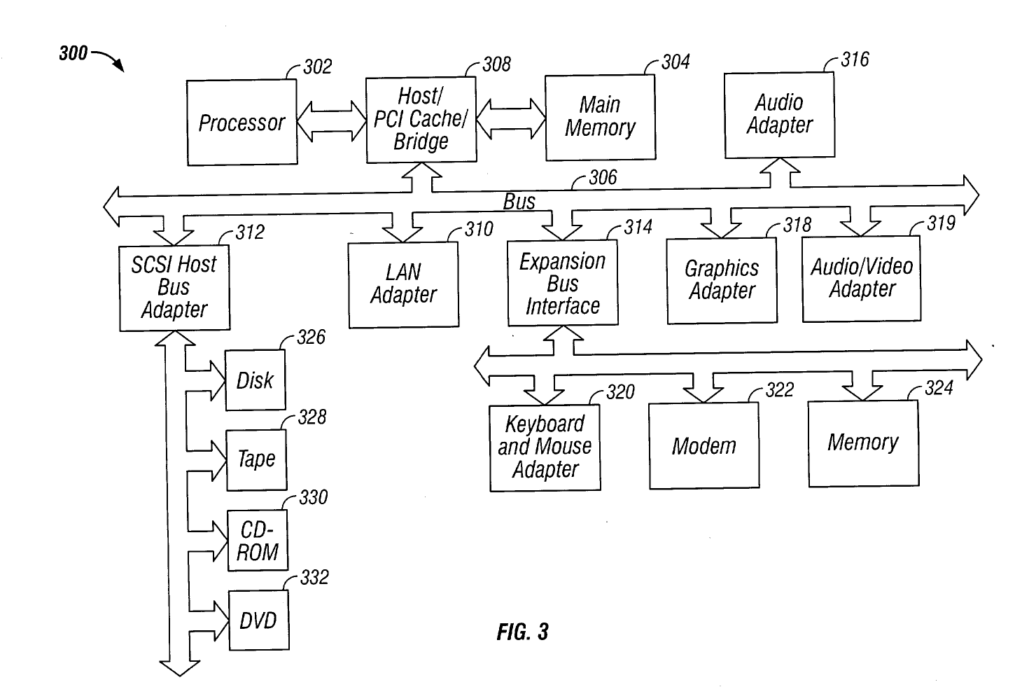

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Product returns often require a customer to obtain a Return Material Authorization (RMA) number before making a return. The customer first contacts the company in question and informs the company of the return. The company then issues a RMA number to the customer. The RMA number helps to alert company personnel of return and helps to trace the history of the product in question by matching it with the customer when it arrives back in the company's possession. The present invention provides a method of automatically matching returned items to authorized returns and acknowledging the receipt of the items in inventory in one integrated process.

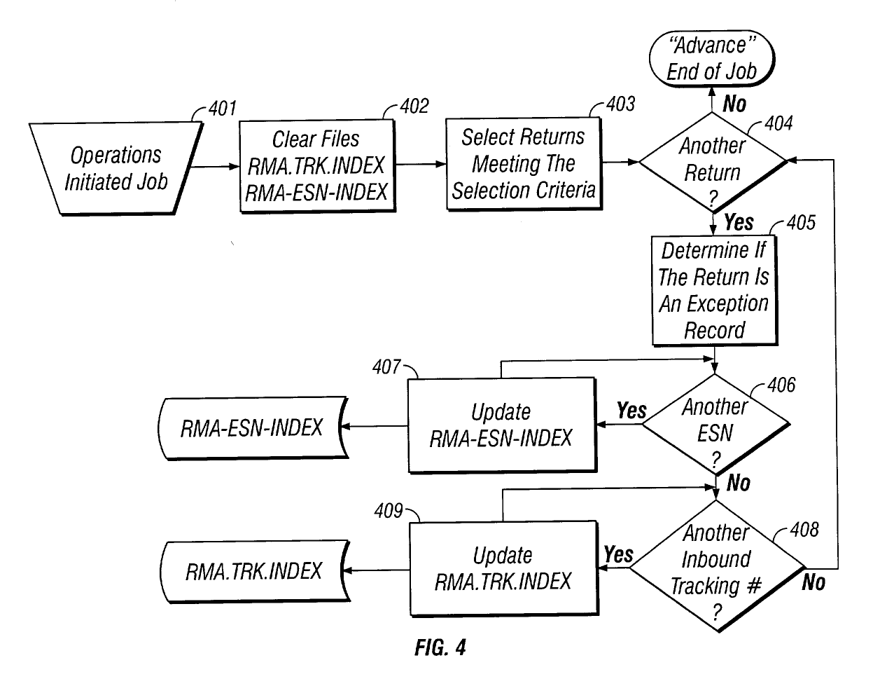

Referring to FIG. 4, a flowchart illustrating the process of building indices for return receipts is depicted in accordance with the present invention. The process begins with a manual initiation of a job (step 401). The system clears its RMA files (step 402). These files include a RMA tracking index and a RMA Electronic Serial Number (ESN) index. A new file is built every night based on all the RMAs in the system, their associated ESNs, and the inbound tracking numbers. The RMA number is assigned at the time it is received through a customer service channel. At this point in time, the RMAs have already been assigned. The objective is to build an index by ESN based on the existing RMA records in the Return Order Header (ROH) file.

The system selects returns that meet specified criteria (step 403). These criteria include Remaining Quantity, Inbound Tracking Number, ESN and date range for return policies. Remaining Quantity represents items that have not been returned and received into the computer. The Inbound Tracking Number is taken from the return label included with the order. The Indices are built based on the ESN number, so if the record in the RMA files does not contain an ESN number, it is excluded from the selection criteria. If a particular Date Range has not been specified, the system uses a default of seven days.

After returns meeting the criteria have been selected, the system retrieves the first RMA in the group (step 404) and determines if the return is an exception record (step 405). If it is an exception record the, index record is flagged with a “Y”. Criteria for exception include: more than one ESN on the RMA, if the Return Order Detail (ROD) file is blank, or if there is more than one Tracking Number on the RMA. A blank ROD file should be rare because the ROD field is the Lot Sequence Number.

The system retrieves the ESN associated with the return (step 406) and enters it into the RMA ESN index file (step 407). The system then returns to step 406 and checks for additional ESNs associated with the return (i.e. multiple items included in the return). If there are no additional ESNs associated with the return, the system retrieves the inbound tracking number for the return (step 408) and enters this into the RMA tacking index file (step 409). The system then returns to step 408 and checks for additional tracking numbers.

After the ESN(s) and tracking number(s) are entered into the files, the system returns to step 404 and goes through the selected returns until all the selected records are processed.

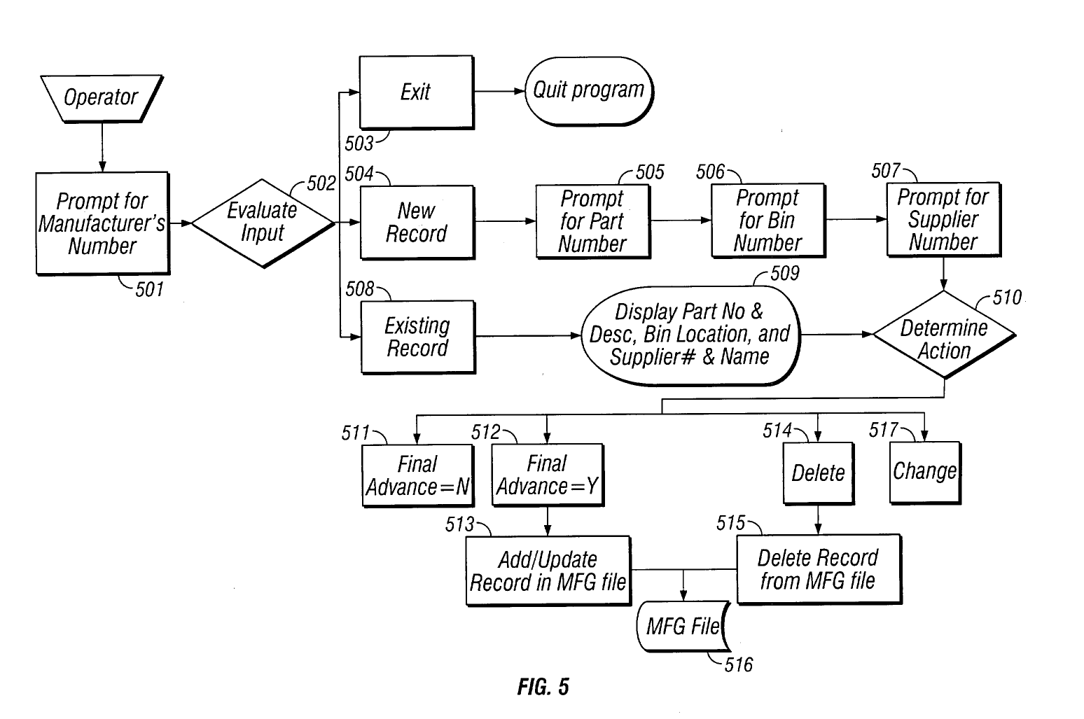

Referring now to FIG. 5, a flowchart illustrating the process of maintaining a manufacturer file is depicted in accordance with the present invention. This process allows the receiving point to directly update manufacturers concerning returned items. The process begins when an operator receives a prompt for a manufacturer's number on the returned item (step 501). This number is used to identify the manufacturer that makes the item in question. When the operator enters the number, the system evaluates the input (step 502) and decides between one of three courses of action.

The first option is to exit (step 503) and quit the program. Examples of why the system might quit include being in the wrong program or the personnel taking a break. If the item in question has not previously been returned, a new record is set up for that item (step 504). The system prompts the operator for the item's part number (step 505) as well as the number of the bin in which the returned item has been placed (step 506). The system then prompts for the supplier number, which helps track the source of the returned item (step 507).

If the item in question has been previously returned, the system consults an existing record for that item (step 508). The system displays the record containing the part number and description, bin location and supplier number and name (step 509).

Once the system has the necessary information on the returned part, it can determine the appropriate action to take from there (step 510).

The system has four options with regard to the item. The first option is to not perform any changes/updates to the manufacturer file. All changes/input are abandoned (Step 511). This option allows for editing in case of incorrect data entry. The second option is to allow a final advance (step 512) and add to and update the record in the manufacturing file (step 513). The third option is to delete the item (step 514) and remove the record from the manufacturing file (step 515). This might be done if, e.g., the item in question is damaged beyond repair. In the case of either adding/updating or deleting, the change is noted in the manufacturer's file 516.

The fourth option is to make some change to the item record (step 517), which provides another opportunity to edit the entered data.

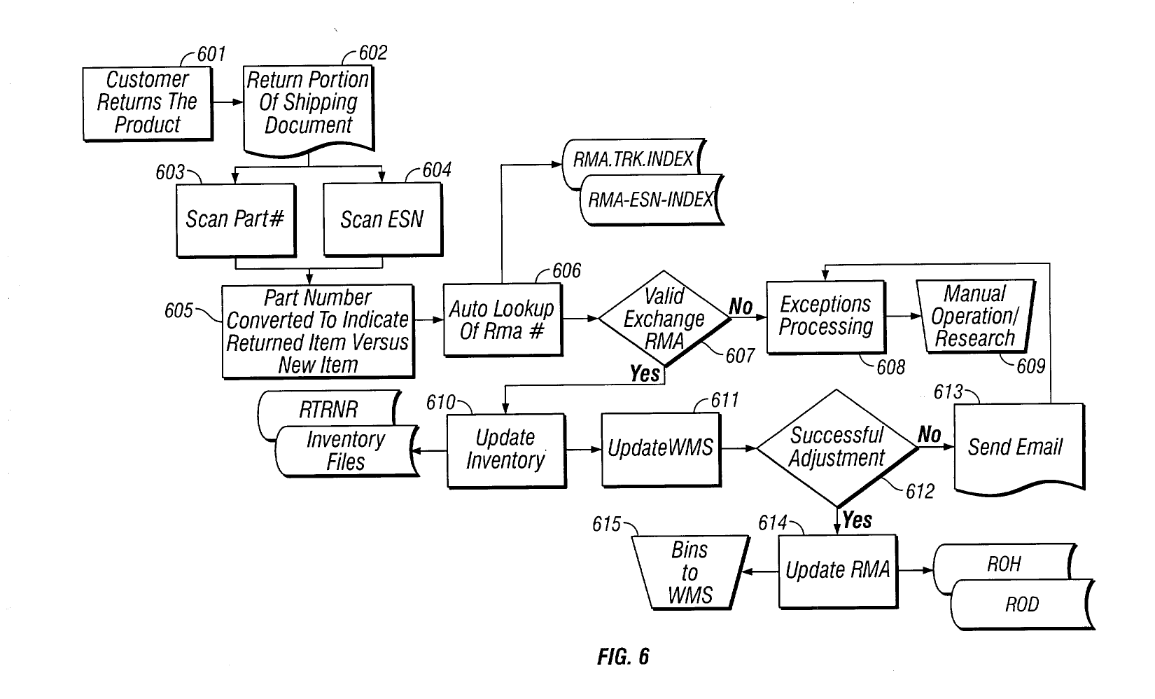

Referring to FIG. 6, a flowchart illustrating an automated process of receiving return material authorization (RMA) orders is depicted in accordance with the present invention. The process begins when a customer returns an item (step 601), ideally along with the return portion 602 of the shipping document that was originally sent with the item in question. When the item is received at the warehouse, the part number (i.e. bar code) is scanned (step 603) and the electronic serial number (ESN) is scanned as well (step 604). Next, the part number is converted to a new number, which indicates a refurbished item versus a new item (step 605).

The system then looks up a RMA number, which the customer would have received before returning the item (step 606). The RMA number can be found in either the RMA tracking index or RAM ESN index, described above. The system determines if there is indeed a valid exchange RMA for the returned item (step 607).

If there is no valid RMA for the returned item, the item enters exceptions processing (step 608). This further involves a manual operation and research on the part of warehouse personnel to look up the item and determine if the return is valid (step 609).

If there is a valid RMA exchange number for the returned item, the inventory files and Returns Register file are updated (step 610). This brings the item back into inventory so it can be accounted for and tracked, but the item is also flagged in the inventory files as a damage repair or vendor overstock item. Flagging the item prevents the inventory system from assuming that the returned item is available to be sold and shipped. The flag ensures that no damaged inventory is included in the calculation of available inventory for new orders being placed.

A warehouse management system (WMS) is updated (step 611) and the system determines if the adjustment in the WMS was successful (step 612). If the adjustment is not successful, an email requesting a manual fix is sent to a technician (step 613), and the item enters exceptions processing (step 608). The WMS is a warehouse execution system that the inventory is moved to once it is received. All damaged inventory is consolidated into the WMS, which acts as a single point to return damaged inventory to suppliers for repair. It is a separate standalone application. All return-to-vendor orders are created in the WMS. This includes Warranty Exchange, wherein credit is given once the ESN is matched as part of the auto-receipt program.

If the WMS adjustment is successful, the RMA is updated (step 614). This includes updating the Returns Order Header (ROH) file 617 and Returns Order Detail (ROD) file 618. The RMA number is closed after all of the return items have been entered and are accounted for. If the item requires a repair, a Service Repair Order (SRO) label 615 is created for the item, and the item is moved from the returns bins to the WMS (step 616).

The process of building indices for return receipts depicted in FIG. 4 is performed by the Operations department on a nightly basis. The process of maintaining a manufacturer file as depicted in FIG. 5 is performed on demanded by a user to update the files. The process of receiving RMA orders as depicted in FIG. 6 will depend on the other two operations.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

We claim:

1. A method for processing product returns, the method comprising the computer implemented steps of:
creating an index of return authorization numbers;
in response to a single input of an identification of a returned item:
matching the returned item with a return authorization number in the index, wherein the return authorization number may be associated with a plurality of returned items;
updating inventory files to include the returned item, wherein the returned item is specially designated as a return that is not immediately available for resale; and
updating a warehouse management system to include the returned item, wherein the warehouse management system tracks all items requiring return to original suppliers for repair.

2. The method according to claim 1, further comprising updating a manufacturer file that allows the manufacturer to identify the returned item as well as the source of the returned item.

3. The method according to claim 1, further comprising creating a service repair order for the returned item.

4. The method according to claim 1, further comprising creating a return-to-manufacturer order and an account receivable for warranty exchange.

5. The method according to claim 1, wherein the identification of the returned item is an electronic serial number.

6. The method according to claim 1, wherein the identification of the returned item is an inbound tracking number.

7. The method according to claim 1, wherein the single input of identification comprises scanning a barcode.

8. A computer program product in a computer readable medium, for processing product returns, the computer program product comprising:
first instructions for creating an index of return authorization numbers;
in response to a single input of an identification of a returned item:
second instructions for matching the returned item with a return authorization number in the index, wherein the return authorization number may be associated with a plurality of returned items;
third instructions for updating inventory files to include the returned item, wherein the returned item is specially designated as a return that is not immediately available for resale;
fourth instructions for updating a warehouse management system to include the returned item, wherein the warehouse management system tracks all items requiring return to original suppliers for repair.

9. The computer program product according to claim 8, further comprising fifth instructions for updating a manufacturer file that allows the manufacturer to identify the returned item as well as the source of the returned item.

10. The computer program product according to claim 8, further comprising fifth instructions for creating a service repair order for the returned item.

11. The computer program product according to claim 8, further comprising fifth instructions for creating a return-to-manufacturer order and an account receivable for warranty exchange.

12. The computer program product according to claim 8, wherein the identification of the returned item is an electronic serial number.

13. The computer program product according to claim 8, wherein the identification of the returned item is an inbound tracking number.

14. The computer program product according to claim 8, wherein the single input of identification comprises scanning a barcode.

15. A system for processing product returns, the system comprising:
an indexing component for creating an index of return authorization numbers;
an input mechanism for inputting an identification of a returned item;
in response to a single input of the returned item's identification:
a cross referencing component for matching the returned item with a return authorization number in the index, wherein the return authorization number may be associated with a plurality of returned items;
a first updating component for updating inventory files to include the returned item, wherein the returned item is specially designated as a return that is not immediately available for resale;
a second updating component for updating a warehouse management system to include the returned item, wherein the warehouse management system tracks all items requiring return to original suppliers for repair.

16. The system according to claim 15, further comprising a third updating component for updating a manufacturer file that allows the manufacturer to identify the returned item as well as the source of the returned item.

17. The system according to claim 15, further comprising an order creation component for creating a service repair order for the returned item.

18. The system according to claim 15, further comprising an invoicing component for creating a return-to-manufacturer order and an account receivable for warranty exchange.

19. The system according to claim 15, wherein the identification of the returned item is an electronic serial number.

20. The system according to claim 15, wherein the identification of the returned item is an inbound tracking number.

21. The system according to claim 15, wherein the single input of identification comprises scanning a barcode.
